(19) United States
(12) Patent Application Publication
(10) Pub. No.: US 2015/0221056 A1
(43) Pub. Date: Aug. 6, 2015

(54) ADJUSTABLE AND DYNAMICALLY UPDATED DYNAMIC ACADEMIC PACE-CHART ENGINE

(71) Applicant: Pearson Education, Inc., Upper Saddle River, NJ (US)

(72) Inventors: Robert Jones, Marshfield, MA (US); Russell LeWinter, Orlando, FL (US)

(73) Assignee: PEARSON EDUCATION, INC., Upper Saddle River, NJ (US)

(21) Appl. No.: 14/170,253

(22) Filed: Jan. 31, 2014

(51) Int. Cl. G06Q 50/20; G06Q 10/10

(52) U.S. Cl. CPC G06Q 50/20; G06Q 10/109

(57) ABSTRACT

In some embodiments, a structure for a course identifies a set of tasks for a user to perform to complete the course. Input from a user can identify a target pacing parameter, such as a target course completion date. A pacing engine can generate a pacing chart based on the target pacing parameter, where the pacing chart identifies a schedule for completing the tasks that will allow the user to meet the target pacing parameter. The user's progress with regard to task completions is monitored, and the pacing chart is dynamically adjusted (e.g., by rescheduling tasks) to reflect new scheduling that will allow the user to meet the target pacing parameter in view of past actual progress.

### BACKGROUND

This disclosure relates in general to methods and systems for automatically and dynamically setting an academic pacing chart with a task timeline (e.g., identifying times for engaging in or completing particular coursework) based on a user's completion-timing goals and actual progress towards completion.

Traditionally, academic syllabi identified when various assignments, quizzes or tests were to be completed. The syllabi were distributed at a beginning of an in-person course and where applicable to all students in the course. Thus, for example, all students were expected to take an exam on the same date at a same time. The modern era affords students greater flexibility in terms of when coursework can be completed. However, syllabi typically continue to be generally applied across all students. That is, students may be presented with a list of coursework to complete within a particular semester. A student may complete the coursework more quickly than expected, though the syllabus continues to reflect only the fixed semester-corresponding temporal information.

### SUMMARY

In one embodiment, the present disclosure provides a method and system for dynamically generating and updating an academic pacing chart (e.g., timeline) tailored to temporal goals set by a particular user and actual progress for the user. For example, a user (e.g., student) may be associated with one or more structures. Each structure may pertain to, for example, a course, competition preparation, an activity or program. Each structure can identify a set of tasks that a student is to complete. The tasks can include required tasks and/or optional tasks.

For each structure, the user can identify a time-related goal. The goal can include, for example, a target number of hours per week to devote to tasks in the structure or a completion date. Based on the goal, a target pacing chart can be generated that includes information about what the user should be completing by intermediate progress points. For example, if a student identifies a target completion date for a course, the target pacing chart may indicate an estimate of a number of hours per week that the student should be devoting to tasks associated with the course. As another example, the target pacing chart may indicate dates by which particular quizzes should be completed. As another example, the target pacing chart may identify a time period during which an assignment should be completed. The target pacing chart can be presented to the student such that she is aware of the estimated pacing requirements for meeting her goal.

The target timeline can be generated using both the user's goal and one or more temporal variables in an applicable structure. For example, the structure may include a plurality of tasks, and each task can be associated with an estimated completion time for that task. The user's goal in the estimated completion times can be used to identify when the user should be completing individual tasks in order to steadily work towards meeting the goal.

After a goal is set, the user's progress can be monitored and compared to target progress as set forth in the target pacing chart. Various techniques can be employed to monitor which tasks a student has completed and when. In one instance, tasks include electronic tasks (e.g., such as reading online material or completing electronic assignments). The monitoring can then include detecting whether and when the student completes the electronic tasks. In another instance, tasks include non-electronic tasks, and the user or another entity can manually indicate whether a given task is been completed.

Based on this monitoring, it can be repeatedly and/or dynamically determined as to whether the user is meeting intermediate target progress points, and it can be predicted as to whether the user will meet her goal. Further, the pacing chart can be dynamically adjusted to reflect new predictions as to what will be required henceforth for the user to meet her goal. For example, if initially it is estimated that a user will need to spend six hours per week on coursework to complete a course by a given date, and the user fails to meet course milestones by target dates, the hour estimate may be increased to seven hours per week.

Thus, a user can be presented with the scheduled plan for meeting a goal. Further, the plan can be dynamically adjusted based on the user's progress. Such techniques can provide users with realistic expectations in terms of what is required to meet a goal and can alert the user if it appears the current efforts are insufficient for meeting this goal.

In some embodiments, an educational academic pacing-chart system is provided for dynamically generating academic pacing recommendations based on goals and empirical user-specific progress. A content availer identifies a course associated with a user; and identifies a structure corresponding to the course, the structure specifying a plurality of tasks. A pacing engine identifies a time period for completing the plurality of tasks and schedules each of the plurality of tasks within the time period. The pacing engine also generates a pacing chart to reflect the scheduling updates the pacing chart based on a status of the user of performance of the plurality of tasks. The updating includes rescheduling at least one task in the plurality of tasks. A usage monitor estimates that the user has not completed a first task of the plurality of tasks. The status of the user of performance of the plurality of tasks is based on the monitoring. An interface engine generates a presentation that includes the updated pacing chart and causes the presentation to be presented to the user.

In some embodiments, a method is provided for dynamically generating academic pacing recommendations based on goals and empirical user-specific progress. A course associated with a user is identified. A structure corresponding to the course is identified, the structure specifying a plurality of tasks. A time period for completing the plurality of tasks is identified. Each of the plurality of tasks is scheduled within the time period. A pacing chart is generated that reflect the scheduling. An estimation is made that the user has not completed a first task of the plurality of tasks. The pacing chart is updated based on the estimating that the user has not completed a first task of the plurality of tasks. A presentation is generated that includes the updated pacing chart. The presentation is caused to be presented to the user.

In some embodiments, a computer-program product tangibly embodied in a non-transitory machine-readable storage medium is provided. The product includes instructions configured to cause one or more data processors to perform a method disclosed herein.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 depicts a block diagram of an embodiment of an academic pacing-chart interaction system;

FIG. 2 depicts a block diagram of an embodiment of an academic pacing-chart engine;

FIG. 3 illustrates a representation of an exemplary structure;

FIGS. 4A and 4B illustrate representations of exemplary pacing charts;

FIG. 5 illustrates a flowchart of an embodiment of a process for generating an initial target pacing chart based on a user's goal;

FIG. 6 illustrates a flowchart of an embodiment of a process for generating an initial target task timeline based on a user's goal;

FIG. 7 illustrates a flowchart of an embodiment of a process for adjusting a pacing variable based on monitored user progress;

FIGS. 8A-8B illustrate representations of exemplary pacing charts;

FIG. 9 depicts a block diagram of an embodiment of a computer system; and

FIG. 10 depicts a block diagram of an embodiment of a special-purpose computer system.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes can be made in the function and arrangement of elements without departing from the spirit and scope as set forth in the appended claims.

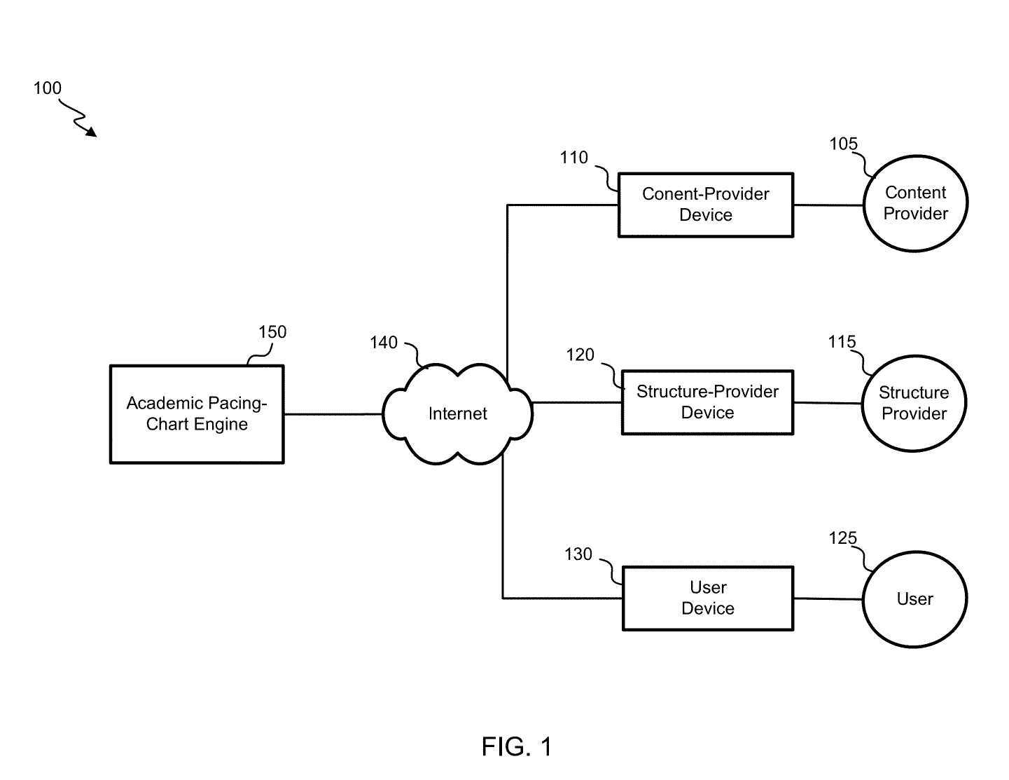

Referring first to FIG. 1, a block diagram of an embodiment of an academic pacing-chart interaction system 100 is shown. A content provider 105, structure definer 115 and/or user 125 can interact with an academic pacing-chart engine 150 via respective devices 110, 120 and/or 130 and a network, such as the Internet 140 or a wide area network (WAN), local area network (LAN) or other backbone. In some embodiments, academic pacing-chart engine 150 is made available to one or more of content provider 105, structure definer 115 and/or user 125 via an app (that can be downloaded to and executed on a portable electronic device) or a website. It will be understood that, although only one content provider 105, user 115 and/or user 125 are shown, system 100 can include multiple content providers 105, structure definers 115 and/or users 125.

Content-provider device 110, structure-provider device 120 and/or user device 130 can each be a single electronic device, such as a hand-held electronic device (e.g., a smartphone). It will be understood that content-provider device 110, structure-provider device 120 and/or user device 130 can also include a system that includes multiple devices and/or components. The device(s) 110, 120 and/or 130 can comprise a computer, such as the desktop computer, a laptop computer or a tablet. In some instances, a party 105, 115 and/or 125 uses different devices at different times to interact with the academic pacing-chart engine 150. For example, user 125 may use a mobile phone to set a target online course completion date and can use a laptop computer to access content for the course.

A content provider 105 can provide a content object to academic pacing-chart engine 150, and academic pacing-chart engine 150 can store it in a repository for subsequent use and/or inclusion in structures. A content object can include a, e.g., a text file, formatted document, webpage, image, etc. Content objects can include an informational content object, (e.g., a publication, learning module, learning object or book chapter) and/or an interactive content object (e.g., a dynamic informational learning object that selectively presents information based on user input, a game and/or an assessment, such as a quiz). Some content objects can be provided along with an answer or grading key and/or grading capability (e.g., automatic electronic grading capability).

Content objects can be provided such that they can be accessed by users 125. Thus, content provider 105 can, e.g., upload content to academic pacing-chart engine 150, generate a content object (e.g., by typing text or defining an image, which may be accomplished using an interface provided by system 150), provide a link to a content object, etc. Content provider 105 can further identify properties of or associated with the content object, such as its name, author, level of detail, skill level, concept(s), learning objective(s), content type(s), usage restrictions, and/or language.

A structure definer 115 can interact with academic pacing-chart engine 150 to define a structure. Each structure can be associated with a unit (e.g., an academic unit), such as the course, a program of study, a competition preparation, test preparation or a learning objective.

Each structure can also be associated with one or more entities, such as a teacher, school or grader. Individual structures can further be associated with a grade level, skill level and/or subject.

The structure can include structure elements, such as tasks, evaluation points and/or other events. Tasks can include self-study or self-practice tasks, such as reviewing material, practicing a concept, completing an assignment, engaging in a module, etc. Tasks can also or alternatively include group tasks, such as participating in a group to complete an assignment or participating in a group discussion. Tasks alternatively or also include evaluation tasks, such as taking a quiz for a test or submitting an assignment. Thus, an evaluation task can precede an evaluation point. A structure element can reference one or more content objects. For example, a task can include partly or fully completing an interactive content object or partly or fully reading a content object. The structure element can refer to each referenced content object by name, with a link or with another type of identifier.

Elements within a structure can include required elements that must be completed and/or optional elements. In some instances, an element is a combination of the required and optional element where, for example, a user is allowed to select between a set of elements, though it is required that at least one be completed. The structure can identify whether all elements are required, whether all elements are optional, which elements are required (or optional) or how many elements are required. The structure can identify conditions for gaining access to a structure element or for completing the structure element. For example, a structure can indicate that Quiz 1 must be completed before beginning Quiz 2, or than a student must receive an above-threshold score on a practice quiz before beginning a graded quiz. Such conditions can therefore identify a sequence, or a sequence can be otherwise indicated within the structure. It will be appreciated, however, that in some instances, a structure lacks a sequence. A user may then be able to complete structure elements (or access element-referenced content objects) in any given order (or at least with some degree of order flexibility).

Parts of the structure can be associated with time estimates. For example, each of one, more or all tasks identified in a structure can be associated with an estimated time for completing the task. As another example, each of one, more or all structure elements can be associated with the progress position (e.g., indicating that completion of the given element is estimated to indicate that a user has completed 25% of the structure). The time estimates can be based on manually entered information (e.g., received from a structure definer) and/or based on an automated process. For example, a reading rate (e.g., a number of pages read per unit time) or question-response time can be estimated, e.g., generally, for a given content object, for a given type of content object, for a given question type, for a given user, for a group of users (e.g., within a grade or having a similar academic-performance metric) and/or for a structure. A time estimate associated with a reading assignment can then be determined based on the estimated reading rate and a number of pages in the assignment or based on an estimated response rate and a number of questions. Thus, in some instances, a time estimate is a specific to a user. As another example, a time for completing a given electronic assignment can be estimated based on past data indicating how long other students actually spent interacting with the assignment or a duration during which students have the assignment open.

Academic pacing-chart engine 150 can store content objects and structures in one or more data stores. Users 125 can also interact with academic pacing-chart engine 150 in order to use select structures and access content objects (e.g., content objects referenced in the select structures). Academic pacing-chart engine 150 can track individual users' involvement in, for example, courses, competitions, activities, etc. Academic pacing-chart engine 150 can identify one or more structures associated with each such involvement.

In some instances, information from a given structure can be presented to an associated user 125. For example, the information can be presented as a syllabus or a list of recommended and/or required tasks. Academic pacing-chart engine 150 can prompt the user 125 to enter one or more goals relevant to a structure. The goal can include a timing goal, such as a target completion date or completion time period. A completion date can indicate a date by which all required items in a structure are completed, all structure elements in a structure completed, a final event identified within the structure is completed, or a final grade or evaluation is to be performed. A timing goal can alternatively or additionally include a target number of hours to commit per unit time. For example, the goal could include committing six hours per week to work on tasks from a structure. In some instances, a goal could alternatively or additionally identify which parts of a structure a user intends to complete. For example, the structure may have 50 optional tasks, and a user may identify a specific subset of tasks that she intends to complete or a number of tasks that she intends to complete.

Based on a schedule's time estimate(s) and a user's goal(s), academic pacing-chart engine 150 can generate a pacing chart estimated to allow the user to meet the goal(s). For example, in one instance, a user identifies a target completion date. The start date can be identified by the user, assumed to be a current time, identified based on a structure, etc. Based on the start date and the target completion date, academic pacing-chart engine 150 can identify a total target completion time period. Academic pacing-chart engine 150 can then distribute a structure's elements and/or time estimates across the time period. For example, if a combination of time estimates for some or all of a structure's elements is equal to 100 hours, and the completion time period is four weeks, academic pacing-chart engine 150 can estimate that a user will need to spend 25 hours per week on structure elements and/or can divide structure elements into individual portions of the time period (e.g., using a technique that distributes the elements to bias towards equilibrating the portions with respect to an interval-level combined time estimate or number of structure elements).

Thus, the pacing chart can indicate a quantity of work that is expected to be performed within an increment of time and/or one or more structure elements that are expected to be completed by a given date. The pacing chart can be presented to user 125 and may provide the user with an indication about whether the identified goal is feasible. User 125 may be allowed to adjust the goal, after which a revised pacing chart can be generated and presented.

Subsequently, academic pacing with an chart engine 150 can monitor a user's progress

For example, estimations can be performed as to when a user completes a task based on when the user accesses, interacts with or submits a particular content object. Completion of various tasks can be mapped to the structure, and an actual progress can be determined. An actual progress at a particular time point within the time period can be compared to a target progress as identifiable from the pacing chart. Based on this comparison, it can be predicted whether the user will meet his goal. Further, the pacing chart can be updated based on a current progress to reflect an estimated hour commitment or task-completion schedule that would allow a user to meet a goal. For example, if an initial pacing chart indicated that a user would need to complete two quizzes per week for four weeks to meet a goal, but the progress monitoring indicated that the user completed three quizzes in each of the first two weeks, an updated pacing chart could indicate that the user could slow her pace to complete only one quiz per week and the remaining two weeks.

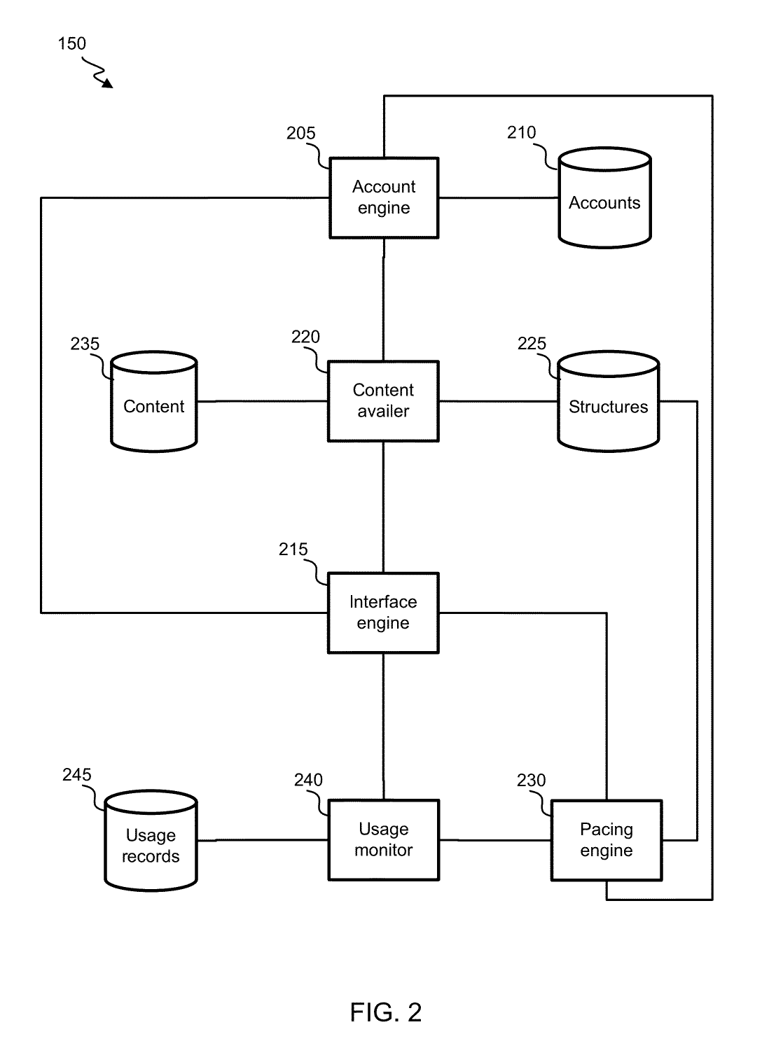

Referring next to FIG. 2, a block diagram of an embodiment of academic pacing-chart engine 150 is shown. Academic pacing-chart engine 150 can be, in part or in its entirety, in a cloud. In some instances, at least part of academic pacing-chart engine 150 is present on a device, such as a structure-definer device 120. Thus, academic pacing-chart engine 150 can include a distributed system.

Academic pacing-chart engine 150 includes an account engine 205, which generates and maintains accounts for users 125 and verifies identities of users 125. Account engine 205 can collect, e.g., personal (e.g., name, email address, residence address, telephone number and occupation), academic (e.g., grade level, current grade, school, one or more teachers, interests, course history, and course enrollment), and/or login (e.g., username and password) information. Account information can be stored in account data store 210. Further, account engine 205 can characterize a system-accessing party as a particular user 125 (e.g., based on a login name or device identifier) and can verify an identity of take user by, e.g., ensuring that information entered by the party (e.g., login information) matches that in a stored account.

Thus, account engine 205 can interact with interface engine 215 both during account generation and account verification. For example, interface engine 215 can provide one or more interfaces that allows one or more parties (e.g., a user, a teacher and/or an administrator) to enter information required to set up a new account (e.g., personal, academic and login information). Subsequently, interface engine 215 can provide a login interface that allows a user to enter login information, which can be verified prior to providing the user with access to a corresponding account, one or more structures and/or one or more content objects.

Interface engine 215 can generate displays or screens that convey information or content and/or that receive input. The displays or screens can be dynamic, such that the content displayed changes, for example, in response to an automatic update or user input. The displays or screens can be ones that can be presented on a device, such as a user device, computer and/or mobile device. The displays or screens can be customized based on a particular presentation device (e.g., a resolution, screen size, operating system, web browser, etc.) and/or preferences (e.g. the preferences a user indicating how content is to be displayed and/or what types of content displayed).

A content availer 220 can identify one or more structures (stored in structures data store 225) associated with a user. In some instances, structure data store 225 associates each of one, more or all stored structures with an involvement (e.g., course, activity, competition, sport, hobby, etc.). Further, an account of a user may identify particular involvements (e.g., course enrollments, competition enrollment and sport participation). Content availer 220 can then identify the appropriate structures for the particular involvements.

A structure can identify a set of tasks and/or topics. In some instances, but not others, the structure specifies at least some degree of order for the tasks, such that it is recommended or required that a specific task be completed before another specific task. The structure can identify a variety of types of information. For example, for a given task, the structure can indicate whether the task is required or optional, whether there is a time limit for completing the task, whether the task must be completed by a particular date, whether another task must be performed prior to completing the task, the type of task, a key word or concept associated with the task, a degree of difficulty, one or more content objects associated with the task, an average score, etc.

Interface engine 215 can present a representation of part or all of a structure (e.g. corresponding to one of the user's involvements). The representation can include, for example, a list of tasks to complete, influence of each of one or more times on a grade, estimates of time required to complete each of one or more tasks, whether each of one or more tasks is required, etc. The recommendation may further include a default completion time period and/or completion date. The recommendation counsel or alternatively include a default pacing chart, which indicates tasks to be performed within particular time intervals.

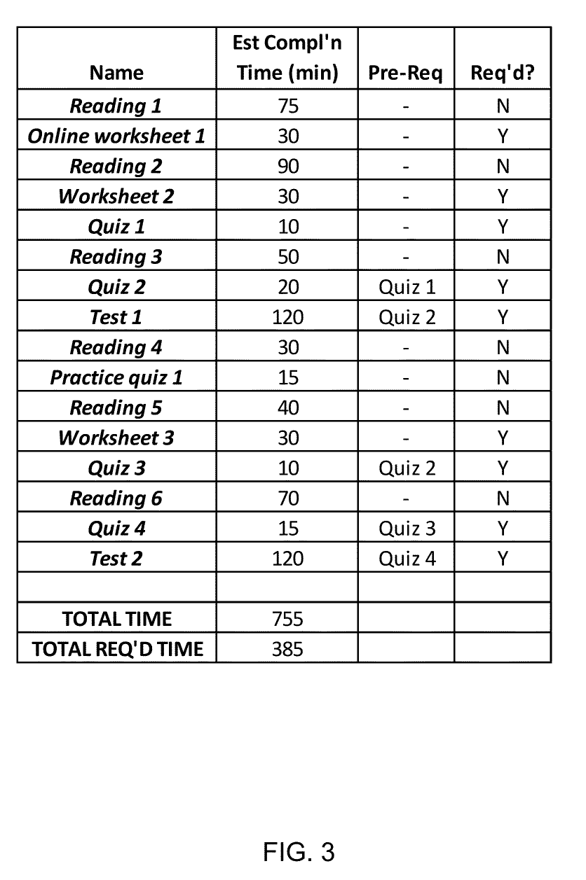

FIG. 3 illustrates a representation of an exemplary structure, which may correspond to an online course. The structure identifies 16 tasks of various types. For each task, the representation identifies an estimated time for completing the task. The representation further indicates whether there is any prerequisite for starting or completing the task and whether it is required that the task be completed.

Interface engine 215 can receive one or more goals (e.g., one or more target pacing parameter) from a user with respect to a structure (e.g. after presenting information about the structure). A goal target pacing parameter could include, for example, a target completion date, a target completion time period, a target overall or per-time-interval time commitment, and/or progress goals (e.g., completing a midterm by a particular date).

A pacing engine 230 can use the goal(s) in the corresponding structure to develop a pacing chart. The pacing chart can be of a variety of formats and can serve to generally provide one or more recommendations in terms of how the user can work through at least part of the structure to obtain their goal(s). Frequently, the recommendations will include time-based recommendations, such as committee a particular number of hours per week to tasks in a structure or completing particular tasks by or on a particular date or within a particular time interval.

In one instance, pacing engine 230 begins by defining a target completion time period. The time period can be defined based on a user goal. The time period can be discretized into multiple time intervals (e.g., of a same duration, such as an individual week), or the time period can be discretized using multiple dates (e.g., suggested task completion or task performance dates). In the former case, a duration or number of time intervals may be set to a default value or user-selected value. Time intervals may be non-overlapping or over-lapping. In one instance, time intervals corresponding to one type of task do not overlap with each other, though they overlap with time intervals corresponding to another type of task. In some instances, the discretization is performed to avoid or reduce recommended work or task completions on particular dates (e.g., holidays or user-identified exclusion dates), types of days (e.g., weekends or weekdays) or times of day (e.g., evenings or work hours).

Following the discretization, structure elements can be disbursed among the discretized intervals or dates. For example, one or more tasks can be assigned to a time interval, or one or more tasks can be assigned to particular date(s) (such that it is recommended to work on the task on and/or complete the task by that date). The disbursement can be based on a number of tasks (or tasks of a given type, such as required tasks) in a structure and/or time estimates of particular tasks. In one instance, a combined time estimate is set to a combination of time estimates for all tasks in a structure, all required tasks in a structure or another set of tasks in a structure (e.g., all reading or studying tasks). The combined time estimate can be divided by a number of time intervals, to identify an approximate time-commitment estimate per interval. Tasks can be assigned to intervals in a manner such that a combination of time estimates for tasks assigned to each interval is approximately equal across intervals and/or meets some other distribution criteria.

In one instance, a separate time interval and/or date is used for each of one, more or all tasks in a structure. A duration of a time interval or spacing between dates can be set based on a time estimate for the task.

Pacing engine 230 can generate a pacing chart that reflects the goal-based allocation of structure elements in a time-based manner. The pacing chart can include or can be built on an array or table and/or can be represented as such or graphically. A user can be presented with a representation of a pacing chart.

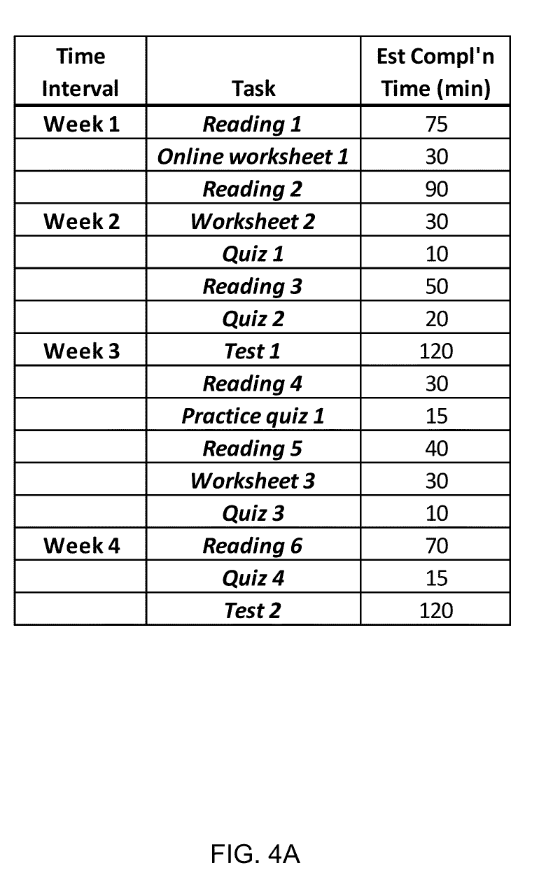

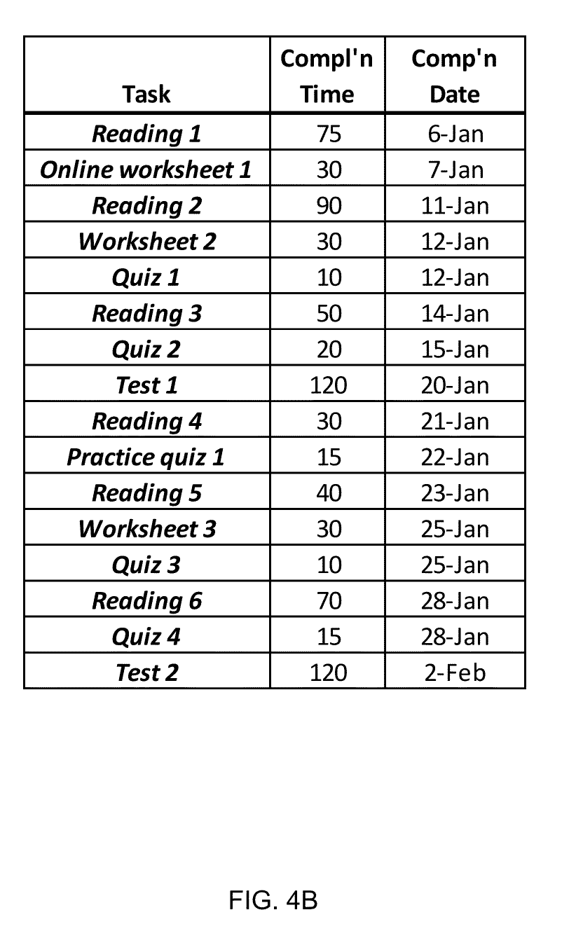

FIGS. 4A and 4B illustrate representations of exemplary pacing charts. In FIG. 4A, structure elements are divided among four week-long time intervals. In FIG. 4B, a target completion date is identified for each structure element. The illustrated representations include estimated task-completion times and task names. It will be appreciated that less, more or different information can be presented (e.g., to include a requirement/optional indication, a content-object source, a number of pages and/or questions, one or more keywords, a skill level, a percentage of a group of other users who have completed the task, etc.).

In various embodiments, a user may, or may not, be allowed to modify the pacing chart (beyond merely adjusting the goal). For example, a user may be allowed to delete portions, such as individual tasks, from the pacing chart. Such deletion capability may be restricted to representations of optional structure elements. As another example, a user may be allowed to rearrange work order portions of the pacing chart. Such rearranging could include dragging a representation of a task and dropping it at a new position in the pacing chart. This type of action may cause positions of other portions of the pacing chart to be adjusted as well. In some instances, one or more constraints limit the types of adjustment that a user can make. For example, it may be required that there be no more than five consecutive non-assessment structure elements. If, e.g., a user attempted to make the prohibited adjustment, an identification of this constraint or general adjustment can I am may be present.

Content availer 220 can identify which content objects are to be presented to a user (e.g., and when) based on the structure, pacing chart and/or user input. In one instance, for example, a pacing chart or structure includes an order where one content object is only to be presented once a user has viewed part of another content object, viewed all of another content object, completed part of another content object, completed all of another content object, received an above-threshold score pertaining to another content object and/or skipped or otherwise declined another content object. Thus, in some instances, the structure pacing chart identifies a content object to automatically present (e.g., upon detecting that a user has opened a particular website or app and/or has selected a particular involvement, structure or pacing chart).

In one instance, a user selection indicates which content object, amongst those identified in the structure pacing chart, to present. For example, an interface may show tasks that are to be completed within a particular time interval, and the user can select one task. As another example, an interface may identify a task and allow a user to either complete the task or skip it to another task. As yet another example, interface may identify tasks assigned to multiple time intervals or dates, and allow a user to select a task amongst some or all of the tasks. Once a task is identified, one or more content objects associated with the task can be queued for presentation.

Content availer 220 can then retrieve the one or more content objects from content data store 235. In one instance, a part of the structure or pacing chart and/or a task can include a content object identifier. Content data store 235 can associate content object identifiers with content objects, such that the corresponding content object can be retrieved.

Interface engine 215 can present part or all of the content object to the user. For example, text, graphics, videos and/or soundtracks can be presented. The content can be presented within a webpage and/or app page, via streaming or via download. The content presentation can be static, dynamic or interactive.

A usage monitor 240 can receive and record user input and/or access corresponding to presented content. For example, usage monitor 240 can record whether a content object is presented on a device of a user, when a presentation of a content object begins and/or ends, whether and/or when a user scrolls through the content object or otherwise progresses through the object (e.g., by requesting new pages) and/or whether and/or when a user enters inputs (e.g., answers to electronic assignment, quiz or test questions). The occurrence of, the timing of and/or the type of interactions (e.g., which can include specific answers) can be stored in association with the user in a usage-record data store 245. In some instances, answers are automatically graded and the grade is additionally or alternatively stored in association with the user.

Pacing engine 230 can use this information to identify a user's progress in terms of completing all or portion of a structure or pacing chart. This progress can be measured relative to progress expected by a given date according to a pacing chart. For example, pacing engine 230 can identify tasks that were to be completed by a particular date and determine which of those tasks were actually completed by that date. Pacing engine 230 may further identify which additional tasks (if any) were completed.

Pacing engine 230 can additionally or alternatively use this information to determine whether user is on track to meet an identified goal (e.g., to complete the curriculum a given date or within a given time period) and/or to adjust a pacing chart. The adjustment may reflect which tasks have been completed such that they are not assigned to future time intervals or future dates, to reassign tasks that has been assigned to past time intervals or dates that remained uncompleted and/or to adjust subsequent assignments to correspond to a new (e.g., increased or decreased) working pace in view of a discrepancy between a past actual pace and what was the target pace.

Interface engine 215 can present the user with an indication as to whether they are on track to meet a goal and/or with a revised pacing chart. The presentation can include an option to allow the user to adjust a goal, which can cause pacing engine 232 further modify the pacing chart.

Usage monitoring, updating of the pacing chart, and/or presentation of updates can be repeatedly performed (e.g., at regular intervals, upon detecting elapse of a time interval, upon detecting initiation or completion of a task, upon detecting passing of a target task completion date, upon detecting a user request for an update, etc.).

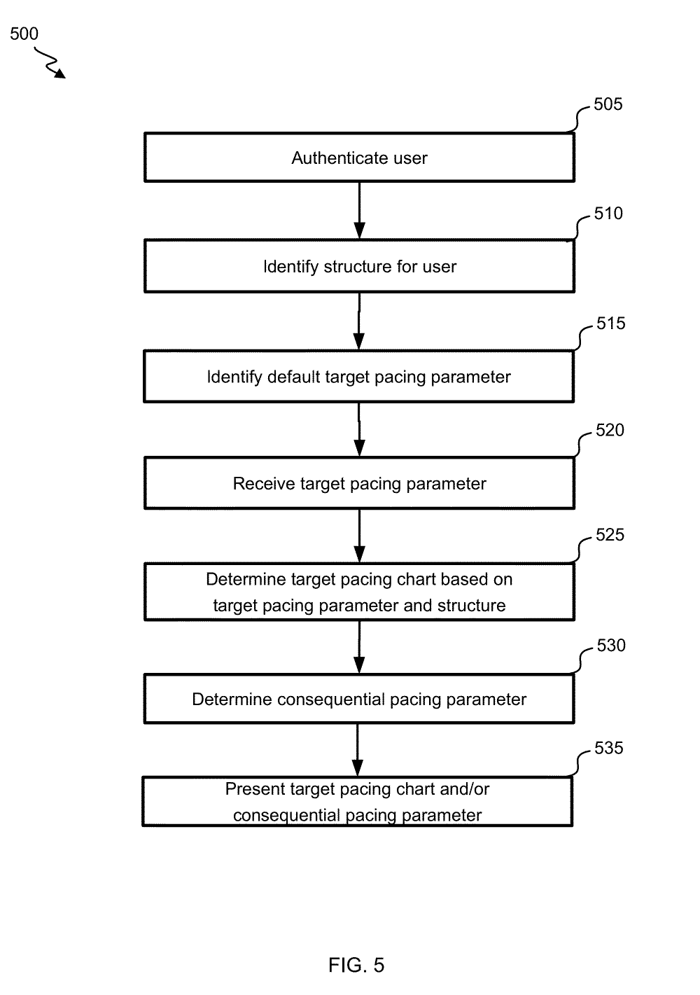

FIG. 5 illustrates a flowchart of an embodiment of a process 500 for generating an initial target task timeline based on a user's goal. Process 500 begins at block 505 where account engine 205 authenticates a user. The authentication can include, for example, ensuring that a received login name and password match those for an account stored in account data store 210 and/or verifying that an attempted access is from a device identified in an account stored in account data store 210. In some instances, the authentication can include confirming that an input identified or selected identifies a name of an enrollee for a particular involvement (e.g., by scanning through one or more enrollee lists for particular involvement or for all involvements).

Content availer 220 identifies a structure for the user at block 510. The structure can correspond to an involvement associated with the user. For example, content availer 220 may identify one or more involvements for the user (e.g., using account data associated with the user in account data store 210). When the user is involved in multiple involvements, an involvement can be automatically selected, or multiple involvements (of the user) can be presented to the user, who can then select one involvement. As another example, a new involvement can be identified for a user (e.g., in response to a user entering a course number or selecting a degree of study within those offered by a university).

Content availer 220 can retrieve the identified structure from structure data store 225.

The structure can include a list of tasks and/or requirements associated with the involvement (e.g., required to complete the involvement). In some instances, part or all of the structure is presented to the user.

Pacing engine 230 identifies a default pacing parameter at block 515. The default pacing parameter may be identified based on, e.g., a current time, a semester timeline, an average past completion time (determined based on activity of other users) of some (e.g., required) or all tasks in the structure, time estimates for tasks in the structure, historical pacing statistics for a user (e.g., to what extent the user typically exceeds or beats time estimates), and/or past target pacing parameters received from the user. For example, if a user frequently strives to complete structures within half of a semester, the pacing parameter may be set to complete the structure in that time. In some instances, a default pacing parameter is included within the structure (e.g., and/or is specified by a course designer or instructor).

The default pacing parameter can include, e.g., a completion time period (for one, more or all structure tasks or for the structure in its entirety), a completion date (for one, more or all structure tasks or for the structure in its entirety), an average number of hours per time increment (e.g., per week) to work on structure tasks, a total number of hours to work on structure tasks, etc.

The default pacing parameter can be presented to the user. The presentation can include a textual or graphical presentation. The presentation can allow the user to accept the default pacing parameter, to reject it and/or to submit another pacing parameter (e.g., to submit a new parameter or to adjust the default parameter).

At block 520, interface engine 215 receives a target pacing parameter. In some instances, the target pacing parameter is inconsistent with the default pacing parameter and/or receiving the target pacing parameter can amount to or be in addition to a rejection of the default pacing parameter. In some instances, the target pacing parameter can be consistently obtained alongside the default pacing parameter and/or no target pacing parameter is received. In such instances, the default pacing parameter can (solely or additionally) serve as a target pacing parameter.

The target pacing parameter can include, e.g., a completion time period (for one, more or all structure tasks or for the structure in its entirety), a completion date (for one, more or all structure tasks or for the structure in its entirety), an average number of hours per time increment (e.g., per week) to work on structure tasks, a total number of hours to work on structure tasks, etc. The default pacing parameter and the target pacing parameter may, or may not, be of a same type (e.g., both being a completion time period).

Pacing engine 230 determines a target pacing chart based on the target pacing parameter and the identified structure at block 525. The pacing chart can include a chart with timing proposals, suggestions or recommendations. For example, for each of one, more or all tasks, the pacing chart can identify a time period during which it is recommended that the task be performed or a date by which it is recommended that the task be completed.

Thus, determining a pacing chart can include distributing tasks across a time period, the time period being defined at least in part based on the target pacing parameter. In one instance, tasks are initially assigned along a time line, and the time line is then scaled to span a target completion time period defined based on the target pacing parameter. In one instance, the pacing chart includes part or all of the scaled time line (e.g., to thereby reflect for each of one, more or all tasks, a scaled task-performance time period and/or target completion date).The scaled time line can be divided into time intervals (e.g., the duration of which may or may not be fixed or constrained), such that a set of tasks can be assigned to a single time interval. The number of tasks assigned to one time interval can thus vary depending on how aggressively the target pacing parameter is set.

Pacing engine 230 determines a consequential pacing parameter at block 530. The consequential pacing parameter can be determined based on the target pacing parameter and/or one or more times estimates for the structure. For example, the structure can be used to determine an overall amount of work required or recommended to complete the structure. Based on the target pacing parameter, it can be estimated how quickly a user will progress through the structure. The consequential pacing parameter can relate to characteristics of this estimated progression.

The consequential pacing parameter can include, e.g., an estimated amount of task-performing time per unit time, a completion time period, a completion date, etc. The consequential pacing parameter and the target pacing parameter may be different types of parameters. For example, if a target pacing parameter for a virtual course includes a 10/15/15 completion date, the consequential pacing parameter can estimate that a student will need to spend 20 hours per week on tasks for the course to meet this date. Conversely, if the target pacing parameter includes a 20 hour per week time commitment, as consequential pacing parameter can estimate that the student will complete the course by 10/15/15.

At block 535, interface engine 215 presents the target pacing chart and/or the consequential pacing parameter to the user. The presentation can include one or more graphics, tables and/or text. Presentation of a target pacing chart can include a presentation of the entire chart or just part of chart. For example, in some instances, a representation of a pacing chart may stop short of specifying each entire task (e.g., specifying that a user is to read pages 100-150 of a textbook) or even specifying a type of task (e.g., specifying that a task is a reading task). Rather, the presentation can identify a number of tasks assigned to specific time intervals, a type of task assigned to a date or time interval, a time estimate for one or more tasks, etc.

The presentation can be static or interactive. For example, an interactive presentation can allow a user to modify a target pacing parameter, modify a consequential pacing parameter (which may also modify the target pacing parameter), delete or move task assignments (e.g., such that they are assigned to a different time), etc. Through interaction, a user may even be allowed to adjust temporal task assignments such that they are not equally distributed across a time period and/or to block off particular dates or days of the week such that tasks are not defined in a manner that would require the user to work on a task or completed task (in various instances) on the blocked days or dates. In some instances, the presentation allows a user to accept or reject the target pacing chart and/or consequential pacing parameter. If the user submits a rejection, a target pacing chart and/or the consequential pacing parameter can be modified in accordance with the newly user-entered target pacing parameter, the default pacing parameter, another pacing parameter, etc.

It will be appreciated that process 500 may be modified in a variety of regards. For example, block 515 and/or block 530 may be omitted from process 500. As another example, process 500 can return to block 515 from block 535 when the user adjusts a same or different target pacing parameter.

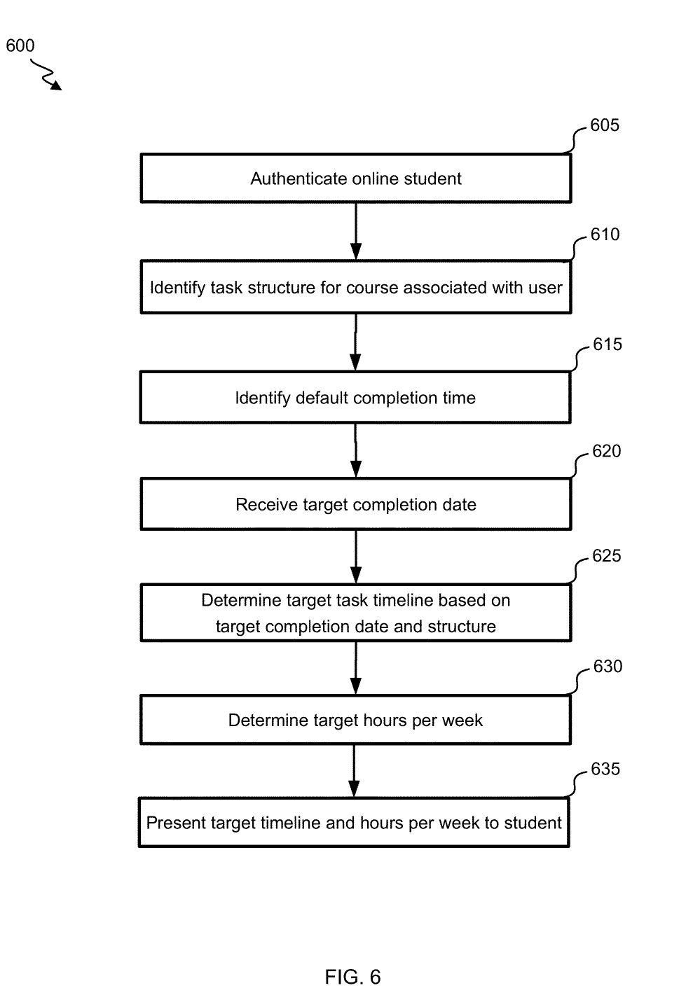

FIG. 6 illustrates a flowchart of an embodiment of another process 600 for generating an initial target task timeline based on a user's goal. Several blocks in process 600 parallel corresponding blocks in process 500. In process 600, the user is an online student. The student is enrolled in an online course, such that the course is one of students involvement here thus, at block 610, the task structure is identified for the course.

The default pacing parameter in this example is a completion time, which can include a default time to complete the course. The default completion time can be, for example, a duration of the semester. The target pacing parameter in this example is a completion date. Thus, in this example, the default pacing parameter and the target pacing parameter differ with regard to their types, though they are related variables.

In process 600, a determination of a target pacing chart includes determining a target task timeline. The target task timeline can identify recommendations as to when particular tasks are to be worked on and/or completed. The determination can be made based on the structure (e.g., tests identified in the structure and/or time estimates for the tasks) and the target completion date.

In this example, determining the consequential pacing parameter includes determining a number of hours per week for the student to engage in tasks for the course in order to complete the course by the target completion date. In some instances, block 630 includes identifying a single target number, such that a recommendation is that a student will engage in coursework for many hours per week each week. In other instances, block 630 include identifying multiple numbers, each of which may be associated with particular weeks. Thus, it may be recommended that the student engage in five hours of work for the course during one week and 10 hours during another. Such variable numbers can be determined based on scheduling preferences the student, a constraint to disallow or to bias against breaking tasks into small components, holiday schedules, etc.

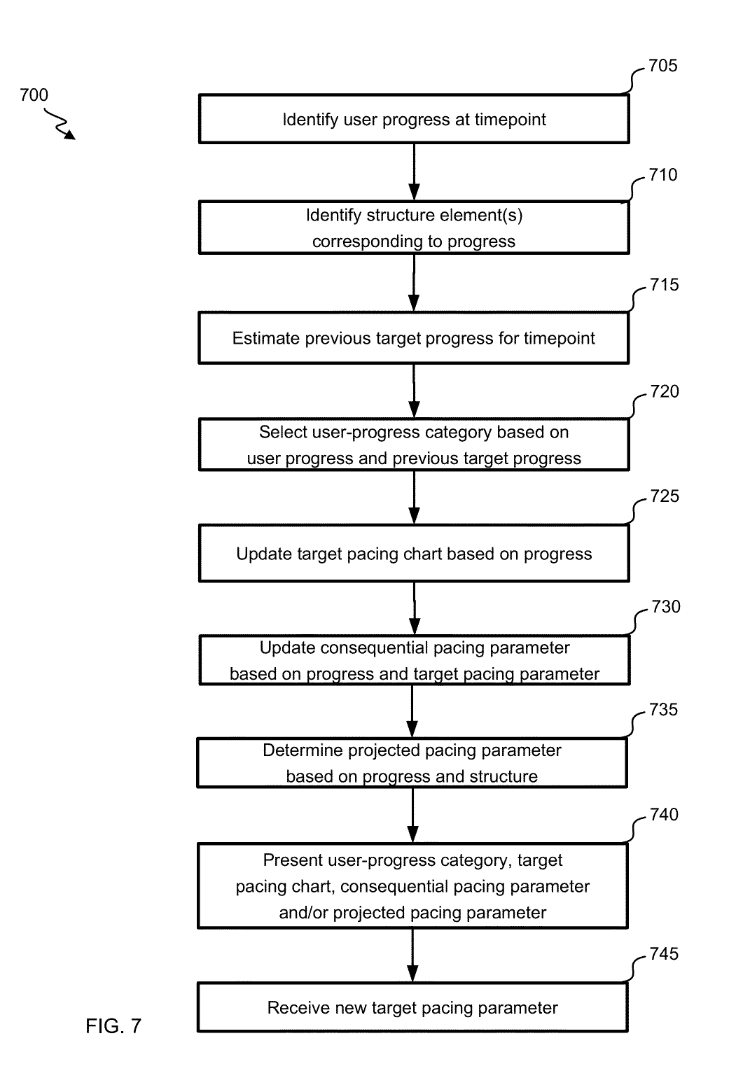

FIG. 7 illustrates a flowchart of an embodiment of a process 700 for adjusting a pacing variable based on monitored user progress. Process 700 begins at block 705 where pacing engine 230 identifies a user progress at a time point. This progress can be based on user data as collected by usage monitor 240. The parameters can include, for example, whether a user has accessed part or all of (e.g., or a threshold amount of) a content object, how long a user has accessed the content object, whether and/or an extent to which a user has provided answers to self-study or assessment questions, whether the user or another party (e.g. an instructor or administrator) has indicated that a task has been completed, whether a user has obtained an above-threshold score (e.g. for self-study or assessment task), whether a user has indicated that she is skipping a task, etc. The progress identification can include identifying particular content objects and/or tasks.

Using this information, an actual progress variable can be determined. For example, the actual progress variable can include a number of tasks performed, a combined time estimate for the tests performed, a number of required tasks performed, a combined time estimate for required tasks performed, actual time during which a user device was showing task-pertinent content, list of some (e.g., required) tasks performed, etc.

Pacing engine 230 identifies one or more structure elements corresponding to the progress at block 710. This identification can be performed by, for example, searching one or more structures to find one or more progress-pertinent tasks or progress-pertinent content objects. Thus, for example, if it is detected that a user has read pages 50 to 100 of Book A, pacing engine 230 can search one or more structures associated with the user to find each tasks reference Book A and specifically, which tasks reference the particular pages. If one task includes reading pages 50 through 80, and another task includes reading pages 81 through 100, the user access can correspond to both tasks. In some instances, pacing engine 230 can also identify which timing recommendations had been made for those tasks. For example, pacing engine 230 can determine whether one or both of the example Book-A tasks were assigned to a past time or whether they remain assigned to a future time. As another example, pacing engine 230 can identify particular time intervals during which the tasks are assigned.

At block 715, pacing engine 230 estimates target progress for the time point. This estimation can be performed using a target pacing chart. For example, pacing engine 230 can identify a number of tasks assigned to previous time points preceding the time point or can identify a combined time estimate for those tasks. This estimation can alternatively or additionally be performed using a target pacing parameter. For example, using a target pacing parameter, pacing engine 230 can identify how far along the time point is relative to a target completion time period. Pacing engine 230 can further identify a number of tasks and/or a combined completion time estimate for a structure, and scale this value based on the relative time point position.

At block 720, pacing engine 230 selects a user-progress category from amongst a set of categories based on the identified user progress in the previous target progress. For example, the set of categories can include categories such as on pace, behind schedule and ahead of schedule. Each category can be associated with one or more thresholds. For example, the “on pace” category may be assigned when a user is completed an exact number of assigned tasks and/or precisely assigned tasks during a time extending to the time point. In some instances, a range is provided. For example, the “on pace” category may be assigned so long as the user is within 5% of the number of assigned tasks. The categorization can depend on precise task assignments, such that a user who has completed Task A (assigned to a previous time interval) and Task B (assigned to a future time interval) but not Task C (assigned to a previous time interval) may be penalized for the incompletion Task C and not rewarded for the completion of Task B. In other instances, the categorization is performed at a higher level, such that the specific identity of the tasks that have been completed is less or not influential, whereas properties associated with those tasks may be more important.

Pacing engine 230 updates the target pacing chart based on the progress at block 725.

The pacing chart can be updated based on the structure elements identified at block 710 and/or based on the progress identified at block 705. In one instance, the pacing chart is updated such that representations of tasks that have been completed are moved to a portion of the pacing chart before a representation of the time point. Similarly, the pacing chart may be updated such that representations of tacit not been completed or moved to a portion of the pacing chart after representation of the time point.

In some instances, updating the pacing chart includes continuing to conform with the target pacing parameter. Thus for example, the updated pacing chart may continue to correspond to a same target completion date, target hours per week, target completion time period, etc. This may result in a change in terms of how many tasks are assigned to a time interval, temporal assignments of particular tasks, and/or (in some instances) a completion time period or date. In some instances, a will be determined that a condition has been met indicating that the pacing chart update need not continue to conform with the target pacing parameter. For example, the condition may indicate that if such conformance would result in an average or maximum task-performing time estimate per unit time to exceed a threshold, the target pacing parameter can be relaxed or ignored.

At block 730, pacing engine 230 updates the consequential pacing parameter based on the progress and a target pacing parameter. For example, the consequential pacing parameter may be increased, decreased, moved up or moved back. To illustrate, if a user has not performed a number of scheduled tasks, and if the user had submitted a target completion date, the updated consequential pacing parameter can indicate that a user will need to spend more hours per week on the course than previously identified to account for the task backlog.

In some instances, the consequential pacing parameter update and/or the target pacing chart update is also or alternatively based on monitored task-performance characteristics. For example, usage monitor 240 can track an amount of time that a user spends on a given task. This monitor time can be compared to the time estimate for the task to determine an extent to which the user requires more or less tasks time than estimated. Time estimates of all tasks or some tasks (e.g. a similar type) can be adjusted based on such monitoring.

Pacing engine 230 determines a projected pacing parameter at block 735 based on the identified user progress and the structure. The projected pacing parameter can be of a type that corresponds to the target pacing parameter. This projection can assume that a user will not be subsequently adjusting task-performance behaviors and can include an extrapolation. The determination can be based on all past task-performance data for the user, past task-performance data for the user or an applicable structure, recent task-performance data, etc. For example, pacing engine 230 can detect that a user has, over the last week, completed only 80% of the assigned tasks. Using the number of tasks actually completed, the time actually spent on completing the tasks and/or the time estimates associated with the tasks, pacing engine 230 can estimate a structure completion date assuming that the user will continue to devote the same amount of time to the structure's tasks and/or will continue to complete the same number of tasks.

At block 740, interface engine 215 presents the user-progress category, the updated target pacing chart, the updated consequential pacing parameter and/or the projected pacing parameter to the user. When multiple results (e.g. a category and a projected pacing parameter) are presented, they may be presented coincidently or sequentially. In some instances, the user can enter inputs indicative of which results are of interest, after which the identified results can be presented.

The presentation can further include an identification of which tasks have been assigned in the past, which tasks were actually completed, when various task were completed, a number and/or type of task completed, a number and/or type of tasks assigned in the past, the previous pacing chart, a target pacing parameter, the previous consequential pacing parameter, etc. The presentation can further include an indication as to what progress was expected based on a previous target pacing chart.

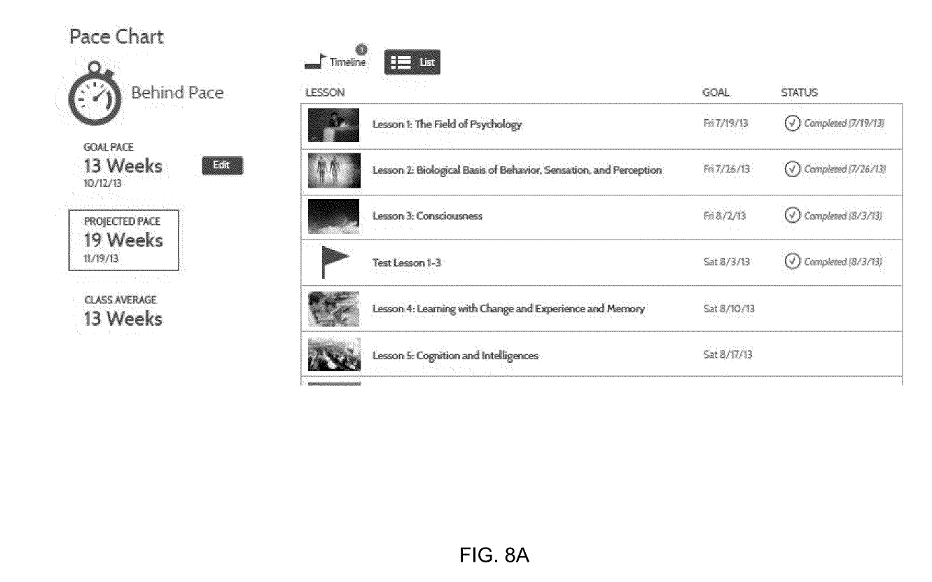

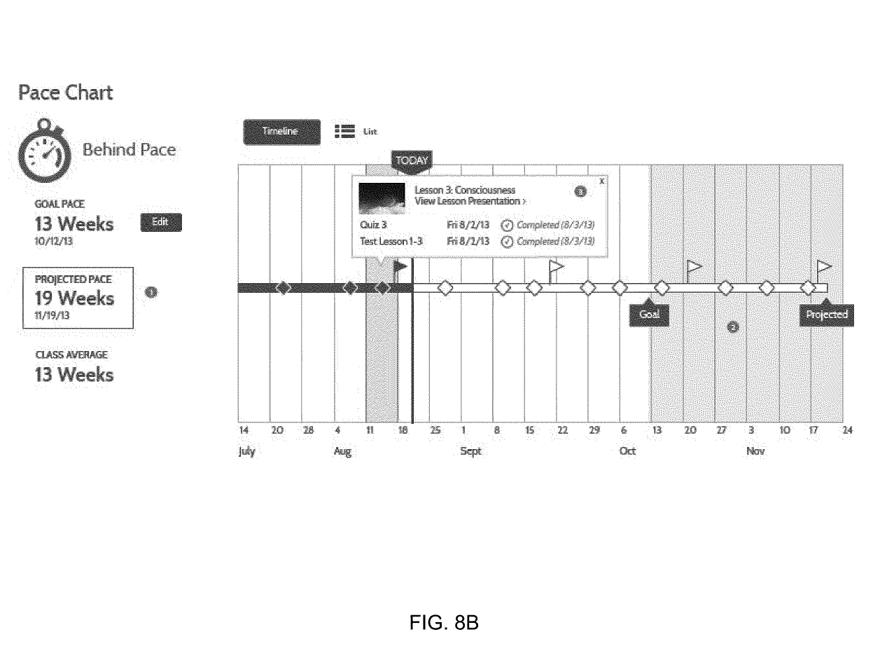

FIGS. 8A and 8B illustrate representations of exemplary pacing charts. The representation in FIG. 8A includes a table, where each row corresponds to a task. Reading-assignment rows included a rectangular graphic, and the test row is marked with a flag. The rows are arranged based on their target task completion date, which is also identified in the table. The table further reflects whether and when the task has been completed. On the left side of the representation, a user-progress category (“Behind pace”) is shown. The target pacing parameter is shown to be 13 weeks, though the projected pacing parameter identified based on the monitored performance is shown as being 19 weeks.

FIG. 8B includes a graphical representation of the same pacing chart. In this instance, ungraded assignments are represented by diamonds and graded tests are represented by flags. Selecting a task representation can cause further detail pertaining to the task to be presented. The horizontal position of the representations indicates an actual completion date (for those tasks completed) or a projected actual completion date for remaining tasks. It will be appreciated that an alternative representation may show an adjusted target completion date for the remaining task. Shaded task representations indicate that the task was completed. A shading in a portion of the horizontal bar represents progress along the structure. The representation identifies a projected pacing parameter that is a projected completion date. This is graphically contrasted to the target completion date. These representations therefore give a user indication that he is behind schedule, to what extent, and what tasks remain.

Returning to process 700, in some instances, at block 745, interface engine 215 receives a new target pacing parameter. The presentation made at block 740 can include a user-entry field that accepts such a modified parameter, or an indication to accept the actual pacing parameter as a new target pacing parameter. When a new target pacing parameter is received, pacing engine 230 can proceed to modify the pacing chart accordingly.

It will again be appreciated that many variations of process 700 are considered. For example, block 720 can be modified such that a comparative progress variable is generated instead of or in addition to the category. To illustrate, rather than merely indicating that a user is behind schedule, the variable may indicate that the user is 10% behind schedule, 5 hours behind schedule or 8 tasks behind schedule. As another example, block 745 can be omitted.

It will be appreciated that many variations of this close systems and methods are contemplated. As one example, disclosures herein frequently referred to receiving a target pacing parameter that includes a time-based variable. Disclosures could be modified to receive other types of goals. For example, a user may identify a target grade for course. An engine could then monitor performance on assignments, quizzes, tests, etc. to determine whether the user is on track for receiving the target grade and/or what grades may be needed for subsequent tasks in order to achieve the goal. Such determinations may be accompanied by general study suggestions or additional learning material.

As another example, many examples disclosed herein referred to structures pertaining to a course. Disclosures may be extended to apply to a course of study. For example, a college student may identify a major and a target graduation date. A pacing engine may track completion of various courses to determine whether the student is on track to graduate by the target date.

As yet another example, disclosures may be extended to apply to completion of a project, assignment or test. For example, a student may be practicing for a timed standardized test. Thus, it may be a goal to complete all or a threshold number of questions within a given time period. Pacing engine may then track when a student is answering questions and indicate to the student (e.g., while the student is taking the test) whether she is on track to meet the goal.

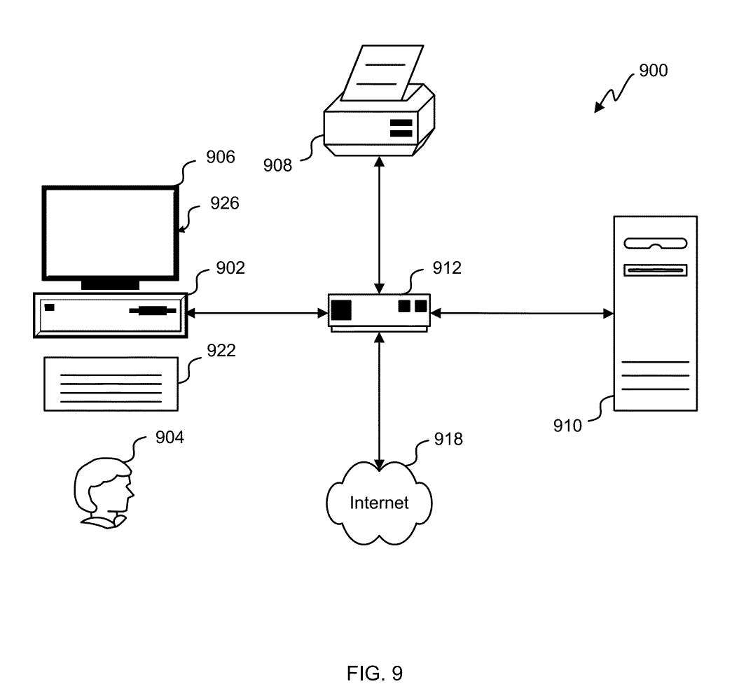

Referring next to FIG. 9, an exemplary environment with which embodiments can be implemented is shown with a computer system 900 that can be used by a designer 904 to design, for example, electronic designs. The computer system 900 can include a computer 902, keyboard 922, a network router 912, a printer 908, and a monitor 906. The monitor 906, processor 902 and keyboard 922 are part of a computer system 926, which can be a laptop computer, desktop computer, handheld computer, mainframe computer, etc. Monitor 906 can be a CRT, flat screen, etc.

A designer 904 can input commands into computer 902 using various input devices, such as a mouse, keyboard 922, track ball, touch screen, etc. If the computer system 900 comprises a mainframe, a designer 904 can access computer 902 using, for example, a terminal or terminal interface. Additionally, computer system 926 can be connected to a printer 908 and a server 910 using a network router 912, which can connect to the Internet 918 or a WAN.

Server 910 can, for example, be used to store additional software programs and data. In one embodiment, software implementing the systems and methods described herein can be stored on a storage medium in server 910. Thus, the software can be run from the storage medium in server 910. In another embodiment, software implementing the systems and methods described herein can be stored on a storage medium in computer 902. Thus, the software can be run from the storage medium in computer system 926. Therefore, in this embodiment, the software can be used whether or not computer 902 is connected to network router 912. Printer 908 can be connected directly to computer 902, in which case, computer system 926 can print whether or not it is connected to network router 912.

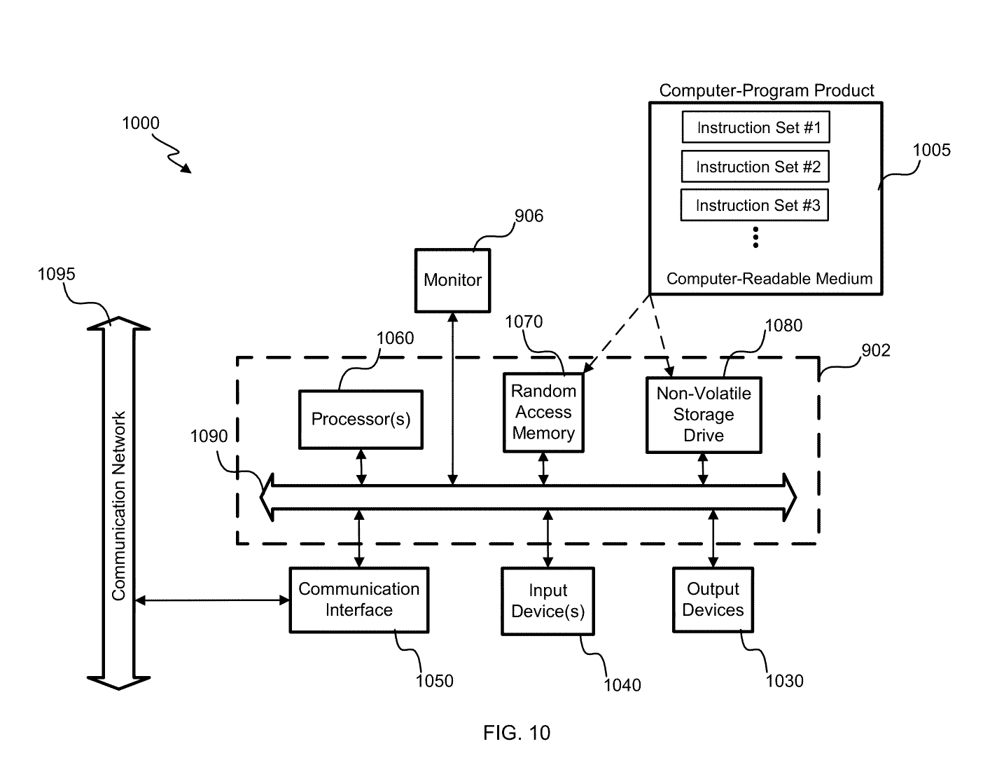

With reference to FIG. 10, an embodiment of a special-purpose computer system 1000 is shown. Academic pacing-chart engine 150 and/or any components thereof are examples of a special-purpose computer system 1000. Thus, for example, one or more special-purpose computer systems 1000 can be used to provide the function of academic pacing-chart engine 150. The above methods can be implemented by computer-program products that direct a computer system to perform the actions of the above-described methods and components. Each such computer-program product can comprise sets of instructions (codes) embodied on a computer-readable medium that directs the processor of a computer system to perform corresponding actions. The instructions can be configured to run in sequential order, or in parallel (such as under different processing threads), or in a combination thereof. After loading the computer-program products on a general purpose computer system 926, it is transformed into the special-purpose computer system 1000.

Special-purpose computer system 1000 comprises a computer 902, a monitor 906 coupled to computer 902, one or more additional user output devices 1040 (optional) coupled to computer 902, one or more user input devices 1035 (e.g., keyboard, mouse, track ball, touch screen) coupled to computer 902, an optional communications interface 1055 coupled to computer 902, a computer-program product 1005 stored in a tangible computer-readable memory in computer 902. Computer-program product 1005 directs system 1000 to perform the above-described methods. Computer 902 can include one or more processors 1060 that communicate with a number of peripheral devices via a bus subsystem 1090. These peripheral devices can include user output device(s) 1040, user input device(s) 1035, communications interface 1055, and a storage subsystem, such as random access memory (RAM) 1070 and non-volatile storage drive 1080 (e.g., disk drive, optical drive, solid state drive), which are forms of tangible computer-readable memory.

Computer-program product 1005 can be stored in non-volatile storage drive 1090 or another computer-readable medium accessible to computer 902 and loaded into memory 1070. Each processor 1060 can comprise a microprocessor, such as a microprocessor from Intel® or Advanced Micro Devices, Inc®, or the like. To support computer-program product 1005, the computer 902 runs an operating system that handles the communications of product 1005 with the above-noted components, as well as the communications between the above-noted components in support of the computer-program product 1005. Exemplary operating systems include Windows® or the like from Microsoft Corporation, Solaris® from Sun Microsystems, LINUX, UNIX, and the like.

User input devices 1035 include all possible types of devices and mechanisms to input information to computer system 902. These can include a keyboard, a keypad, a mouse, a scanner, a digital drawing pad, a touch screen incorporated into the display, audio input devices such as voice recognition systems, microphones, and other types of input devices. In various embodiments, user input devices 1035 are typically embodied as a computer mouse, a trackball, a track pad, a joystick, wireless remote, a drawing tablet, a voice command system. User input devices 1035 typically allow a user to select objects, icons, text and the like that appear on the monitor 906 via a command such as a click of a button or the like. User output devices 1040 include all possible types of devices and mechanisms to output information from computer 902. These can include a display (e.g., monitor 906), printers, non-visual displays such as audio output devices, etc.

Communications interface 1055 provides an interface to other communication networks and devices and can serve as an interface to receive data from and transmit data to other systems, WANs and/or the Internet 918. Embodiments of communications interface 1055 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1055 can be coupled to a computer network, to a FireWire® bus, or the like. In other embodiments, communications interface 1055 can be physically integrated on the motherboard of computer 902, and/or can be a software program, or the like.

RAM 1070 and non-volatile storage drive 1080 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1070 and non-volatile storage drive 1080 can be configured to store the basic programming and data constructs that provide the functionality of various embodiments of the present invention, as described above.

Software instruction sets that provide the functionality of the present invention can be stored in RAM 1070 and non-volatile storage drive 1080. These instruction sets or code can be executed by processor(s) 1060. RAM 1070 and non-volatile storage drive 1080 can also provide a repository to store data and data structures used in accordance with the present invention. RAM 1070 and non-volatile storage drive 1080 can include a number of memories including a main random access memory (RAM) to store of instructions and data during program execution and a read-only memory (ROM) in which fixed instructions are stored. RAM 1070 and non-volatile storage drive 1080 can include a file storage subsystem providing persistent (non-volatile) storage of program and/or data files. RAM 1070 and non-volatile storage drive 1080 can also include removable storage systems, such as removable flash memory.

Bus subsystem 1090 provides a mechanism to allow the various components and subsystems of computer 902 communicate with each other as intended. Although bus subsystem 1090 is shown schematically as a single bus, alternative embodiments of the bus subsystem can utilize multiple busses or communication paths within computer 902.

Specific details are given in the above description to provide a thorough understanding of the embodiments. However, it is understood that the embodiments can be practiced without these specific details. For example, circuits can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps and means described above can be done in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. An educational academic pacing-chart system for dynamically generating academic pacing recommendations based on goals and empirical student-specific progress, the educational academic pacing-chart comprising:
a content availer that:
identifies a course associated with a first student and with a second student, wherein a plurality of students are enrolled in the course, and wherein the plurality of students includes the first student and the second student; and
identifies a syllabus corresponding to the course, the syllabus specifying a plurality of tasks;
a pacing engine that, for each of the first student and the second student:
identifies a default target completion time or a default target completion time period for the course based on the syllabus;
identifies, based on input received from the student that identifies a user-specific target completion time or user-specific target completion time period and using one or more processors, a time period for completing the plurality of tasks for the student, the user-specific target completion time or user-specific target completion time period identified based on input received from the first student being different than the user-specific target completion time or user-specific target completion time period identified based on input received from the second student, and the identified time period for the first student being different than the identified time period for the second student;
schedules, using the one or more processors, each of the plurality of tasks within the time period;
generates, using the one or more processors, a pacing chart corresponding to the student to reflect the scheduling;
determines a projected completion time or a projected completion time period based on a user-specific status of the student of performance of the plurality of tasks; and
updates, using the one or more processors, the pacing chart corresponding to the student based on the user-specific status of the student of performance of the plurality of tasks, the updating including rescheduling at least one task in the plurality of tasks;
a usage monitor that tracks, on a student-specific basis, the user-specific status of the first student of performance of the plurality of tasks and the user-specific status of the second student of performance of the plurality of tasks, wherein the user-specific status of the first student indicates that that the first student has not completed a first task of the plurality of tasks; and
an interface engine that, for each of the first student and the second student:
receives the input from the student that identifies the user-specific target completion time or user-specific target completion time period, the user-specific target completion time or user-specific target completion time period being different than the default target completion time or default target completion time period;
causes a first presentation to be presented, via a graphical user interface, the first presentation including an identification of the default target completion time or default target completion time period and an option to provide an alternative user-specific target completion time or alternative user-specific target completion time period, the input received from the student that identifies the user-specific target completion time or user-specific target completion time period being provided via interaction with the option;
generates a second presentation that includes:
the updated pacing chart corresponding to the student
the user-specific target completion time or user-specific target completion time period;
the projected completion time or projected completion time period; and
a user-entry field that accepts input identifying an adjusted user-specific target completion time or an adjusted t user-specific target completion time period; and
causes the second presentation to be presented to the student user.

2. The educational academic pacing-chart system for dynamically generating academic pacing recommendations based on goals and empirical student-specific progress as recited in claim 21, wherein the pacing engine generates a different pacing chart corresponding to another student in the plurality of students enrolled in the course.

3. The educational academic pacing-chart system for dynamically generating academic pacing recommendations based on goals and empirical student-specific progress as recited in claim 21, wherein the usage monitor estimates that the student has not completed the first task by determining that a set of answers corresponding to the first task was not submitted in association with the student.

4. The educational academic pacing-chart system for dynamically generating academic pacing recommendations based on goals and empirical student-specific progress as recited in claim 21, wherein the usage monitor estimates that the student has not completed the first task by determining that part or all of a content object corresponding to the first task had not been presented on a device associated with the student.

5. The educational academic pacing-chart system for dynamically generating academic pacing recommendations based on goals and empirical student-specific progress as recited in claim 21, wherein:
the first task includes one scheduled to have been completed prior to a monitoring time,
the usage monitor determines that the student has not completed the first task by the monitoring time, and
the rescheduling the at least one task includes rescheduling the first task for a time after the monitoring time.

6. The educational academic pacing-chart system for dynamically generating academic pacing recommendations based on goals and empirical student-specific progress as recited in claim 21, wherein the pacing chart identifies, for each of a set of time intervals within the time period, one or more of the plurality of tasks scheduled to be completed within the time interval.

7. The educational academic pacing-chart system for dynamically generating academic pacing recommendations based on goals and empirical student-specific progress as recited in claim 21, wherein:
the interface engine further receives the input from the student;
the input identifies a target completion date for the course; and,
each of the generated pacing chart and updated pacing chart are designed such that the plurality of tasks are to be completed by the target completion date.

8. The educational academic pacing-chart system for dynamically generating academic pacing recommendations based on goals and empirical student-specific progress as recited in claim 21, wherein:
each of the plurality of tasks include a graded task,
the structure further specifies a second plurality of ungraded tasks,
the pacing engine further schedules each of the plurality of ungraded tasks within the time period,
the pacing chart reflects the scheduling of the ungraded tasks, and
updating the pacing chart includes rescheduling at least one ungraded task.

9. A computer-implemented method for dynamically generating academic pacing recommendations based on goals and empirical student-specific progress, the method comprising:
identifying a course associated with a student, wherein a plurality of students are enrolled in the course, and wherein the plurality of students includes the student;
identifying a structure corresponding to the course, the structure specifying a plurality of tasks;
receiving input from the student that identifies a target completion time or target completion time period;
identifying, based on the input received from the student that identifies the target completion time or target completion time period, a time period for completing the plurality of tasks for the student, the identified time period being different than a corresponding time period for completing the plurality of tasks identified for another student in the plurality of students;
scheduling each of the plurality of tasks within the time period;
generating a pacing chart corresponding to the student to reflect the scheduling;
tracking, on a student-specific basis, a status of the student of performance of the plurality of tasks, the status indicating that the student has not completed a first task of the plurality of tasks;
updating the pacing chart corresponding to the student based on the tracking, on the student-specific basis, of the status of the student of performance of the plurality of tasks;
generating a presentation that includes the updated pacing chart corresponding to the student; and
causing the presentation to be presented to the student.

10. The method for dynamically generating academic pacing recommendations based on goals and empirical student-specific progress as recited in claim 9, further comprising generating a different pacing chart corresponding to another student in the plurality of students enrolled in the course.

11. The method for dynamically generating academic pacing recommendations based on goals and empirical student-specific progress as recited in claim 9, wherein the estimation that the student user has not completed the first task includes determining that a set of answers corresponding to the first task was not submitted in association with the student.

12. The method for dynamically generating academic pacing recommendations based on goals and empirical student-specific progress as recited in claim 9, wherein the estimation that the student has not completed of the plurality of tasks includes determining that part or all of a content object corresponding to the first task had not been presented on a device associated with the student.

13. The method for dynamically generating academic pacing recommendations based on goals and empirical student-specific progress as recited in claim 9, wherein:
the first task includes one scheduled to have been completed prior to a monitoring time,
the estimating that the student has not completed the first task of the plurality of tasks includes estimating that the student has not completed a first task of the plurality of tasks by the monitoring time, and
the rescheduling the at least one task includes rescheduling the first task for a time after the monitoring time.

14. The method for dynamically generating academic pacing recommendations based on goals and empirical student-specific progress as recited in claim 9, wherein the pacing chart identifies, for each of a set of time intervals within the time period, one or more of the Currently amended of tasks scheduled to be completed within the time interval.

15. The method for dynamically generating academic pacing recommendations based on goals and empirical student-specific progress as recited in claim 9, wherein:
the input received from the student identifies a target completion date for the course; and
each of the generated pacing chart and updated pacing chart are designed such that the plurality of tasks are to be completed by the target completion date.

16. The method for dynamically generating academic pacing recommendations based on goals and empirical student-specific progress as recited in claim 9, wherein:
each of the plurality of tasks include a graded task,
the structure further specifies a second plurality of ungraded tasks,
the pacing chart reflects scheduling of the ungraded tasks, and
updating the pacing chart includes rescheduling at least one ungraded task.

17. A computer-program product tangibly embodied in a non-transitory machine-readable storage medium, including instructions configured to cause one or more data processors to perform actions including:
identifying a course associated with a student, wherein a plurality of students are enrolled in the course, and wherein the plurality of students includes the student;
identifying a structure corresponding to the course, the structure specifying a plurality of tasks;
receiving input from the student that identifies a target completion time or target completion time period;
identifying, based on the input received from the student that identifies the target completion time or target completion time period, a time period for completing the plurality of tasks for the student, the identified time period being different than a corresponding time period for completing the plurality of tasks identified for another student in the plurality of students;
scheduling each of the plurality of tasks within the time period;
generating a pacing chart corresponding to the student to reflect the scheduling;
tracking, on a student-specific basis, a status of the student of performance of the plurality of tasks, the status indicating that the student has not completed a first task of the plurality of tasks;
updating the pacing chart corresponding to the student based on the tracking, on the student-specific basis, of the status of the student of performance of the plurality of tasks;
generating a presentation that includes the updated pacing chart corresponding to the student; and
causing the presentation to be presented to the student.

18. The computer-program product as recited in claim 17, wherein the actions further include generating a different pacing chart corresponding to another student in the plurality of students enrolled in the course.

19. The computer-program product as recited in claim 17, wherein:
the first task includes one scheduled to have been completed prior to a monitoring time,
the estimating that the student has not completed the first task of the plurality of tasks includes estimating that the student has not completed a first task of the plurality of tasks by the monitoring time, and
the rescheduling the at least one task includes rescheduling the first task for a time after the monitoring time.

20. The computer-program product as recited in claim 17, wherein the pacing chart identifies, for each of a set of time intervals within the time period, one or more of the plurality of tasks scheduled to be completed within the time interval.

21. An educational academic pacing-chart system for dynamically generating academic pacing recommendations based on goals and empirical student-specific progress, the educational academic pacing-chart comprising:
a content availer that:
identifies a course associated with a student, wherein a plurality of students are enrolled in the course, and wherein the plurality of students includes the student; and
identifies a structure corresponding to the course, the structure specifying a plurality of tasks;
a pacing engine that:
identifies, based on input received from the student that identifies a target completion time or target completion time period and using one or more processors, a time period for completing the plurality of tasks for the student, the identified time period being different than a corresponding time period for completing the plurality of tasks identified for another student in the plurality of students;
schedules, using the one or more processors, each of the plurality of tasks within the time period;
generates, using the one or more processors, a pacing chart corresponding to the student to reflect the scheduling; and
updates, using the one or more processors, the pacing chart corresponding to the student based on a status of the student of performance of the plurality of tasks, the updating including rescheduling at least one task in the plurality of tasks;
a usage monitor that tracks, on a student-specific basis, the status of the student of performance of the plurality of tasks, wherein the status indicates that that the student has not completed a first task of the plurality of tasks, the status of the student of performance of the plurality of tasks being based on the monitoring; and
an interface engine that:
generates a presentation that includes the updated pacing chart corresponding to the student; and
causes the presentation to be presented to the student.
